(19) United States
(12) Patent Application Publication
(10) Pub. No.: US 2017/0195829 A1
(43) Pub. Date: Jul. 6, 2017

(54) Generalized Short Range Communications Device and Method

(71) Applicant: BRAGI GmbH, Munchen (DE)

(72) Inventors: Luigi Belverato, München (DE); Martin Steiner, München (DE); Peter Vincent Boesen, München (DE)

(21) Appl. No.: 15/391,399

(22) Filed: Dec. 27, 2016

Related U.S. Application Data
(60) Provisional application No. 62/274,012, filed on Dec. 31, 2015.

(51) Int. Cl. H04W 4/00; H04L 29/06; H04M 1/725

(52) U.S. Cl. CPC H04W 4/008; H04M 1/7253; H04L 63/0428

(57) ABSTRACT

A method for generalized short range communication is provided. The method includes establishing a general channel communications linkage for transmission of voice or data from a primary device, communicating the voice or data from the primary device to one or more secondary devices over the general channel, establishing a private channel communications linkage for transmission of data between the primary device and the one or more secondary devices, and changing transmission status of the one or more secondary devices to provide for communications across the general channel communications linkage. The primary device may be a wearable device such as an earpiece, an eyepiece, a set of eyepieces (e.g. glasses), a timepiece, an item of jewelry, an item of clothing or other type of wearable device. The private channel may be encrypted while the general communications channel is not.

### PRIORITY STATEMENT

This application claims priority to U.S. Provisional Patent Application 62/274,012, filed on Dec. 31, 2015, and entitled Generalized Short Range Communications Device and Method, hereby incorporated by reference in its entirety.

### FIELD OF THE INVENTION

The present invention relates to communications. More particularly, but not exclusively, the present invention relates to generalized short range communications.

### BACKGROUND

With the advent of personal communications devices, privacy has been, and continues to be a major concern. The encryption of voice and data as well as secure transmission of said data has been a major issue and concern for people, companies and governments the world over. However, there are other times when there is a need for a generalized short range communication system that is not encrypted, and allows anyone within range to access the data stream. One such example of such a need arises when a device transmits voice or data from a privileged location, such as a stethoscope placed over the heart. Heart sounds are unique and variable based upon position. They also may be transient and intermittent. Consequently, the need arises for the transmission from a wearable device to transfer voice or data streams from the position that they occupy to any available receiver that is within range. Given the issues of the unique spatial positioning of wearable devices, it is desirable in certain circumstances to be able to transmit the findings to any receptor device that is within the short range of transmission of the wearable device. Of course, there are numerous other instances where generalized short range communications systems are needed. Therefore, what is needed is a generalized short range communication device, system, and related methods.

### SUMMARY

Therefore, it is a primary object, feature, or advantage of the present invention to improve over the state of the art.

It is a further object, feature, or advantage of the present invention to improve over the state of the art.

It is a still further object, feature, or advantage of the present invention to allow a user to select a general channel for transmission and reception of data transmitted from one device to others located in close spatial relationship to each other.

Another object, feature, or advantage is to allow the user to select a general channel for transmission and reception of data transmitted from one device to others located in close spatial relationship to each other.

Yet another object, feature, or advantage is to select a general channel for transmission and reception of data transmitted from one device to others located in close spatial relationship to each other.

A still further object, feature, or advantage is to allow a user to select a general channel for transmission and reception of data transmitted from one device to others located in close spatial relationship to each other.

A further object, feature, or advantage is to allow a user to select whether to participate in the sharing or exchange of voice or data through the general channel.

A still further object, feature, or advantage is to allow a user to selectively terminate the sharing or exchange of voice or data through the general channel.

Another object, feature, or advantage is to allow the user to ‘find’ other devices within the general area by selecting the general channel.

Yet another object, feature, or advantage is to allow an action as a beacon if the linkage from the private communications channel to the device initiates the transmission on the general channel.

A further object, feature, or advantage is to allow interaction with other devices also tuned into the general channel after the primary control device initiates the change in transmission status.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by an objects, features, or advantages stated herein.

According to one aspect, a solution is provided that allows the user to select a general channel for the transmission of voice or data from the device. Said device could be a wearable, or other device where there is an advantage of transmission in a general sense to any device that also can be controlled in order to access the general transmission channel. This allows general communication from the device to the surrounding devices, as well as to allow user controlled data transfer and/or exchange. Further, through communications linkages through the private channel, the user may change the transmission status of the secondary device. This would be useful if the secondary device becomes lost. Anyone within the general area would be able to detect the lost device by locating it using the general short range communications channel.

According to another aspect, a method for generalized short range communication is provided. The method includes establishing a general channel communications linkage for transmission of voice or data from a primary device, communicating the voice or data from the primary device to one or more secondary devices over the general channel, establishing a private channel communications linkage for transmission of data between the primary device and the one or more secondary devices, and changing transmission status of the one or more secondary devices to provide for communications across the general channel communications linkage. The primary device may be a wearable device such as an earpiece, an eyepiece, a set of eyepieces (e.g. glasses), a timepiece, an item of jewelry, an item of clothing or other type of wearable device. The private channel may be encrypted while the general communications channel is not.

According to another aspect, a method for controlling communications of a device is provided. The method includes providing a device having a communications system which includes at least one transceiver and configured for establishing a general communications channel with one or more other devices and a private communications channel with one or more other devices, receiving over the private communications channel an instruction to establish the general communications channel and transmit data over the general communications channel, and in response to the instruction, establishing the general communications channel and transmitting data over the general communications channel. The private communications channel may encrypt and decrypt data communicated through it while the general communications channel does not encrypt or decrypt data. The device may be a wearable device such as an earpiece, an eyepiece, a timepiece, an item of jewelry, or an item of clothing. The data transmitted over the general communications channel may be used to assist in locating the device such as when it is lost.

According to another aspect, a device includes a housing, a transceiver disposed within the housing, and a processor operatively connected to the transceiver. The device is configured to establish a general communications channel for unencrypted communications and a private communications channel for encrypted communications. The device is configured to receive an instruction over the private communications channel and in response to the instruction communicate voice or data over the general communications channel. The device may be a wearable device and the housing may be a wearable device housing. The wearable device may be an earpiece, an eyepiece, a timepiece, an article of jewelry, an article of clothing, or other type of wearable device.

### BRIEF DESCRIPTION OF THE DRAWINGS

FIG. 1 illustrates various examples of devices communicating over private and general communications channels.

FIG. 2 illustrates one example of an earpiece in greater detail.

FIG. 3 illustrates one example of a device.

### DETAILED DESCRIPTION

We propose a new and novel solution that allows the user to select a general channel for the transmission of voice or data from the device. Said device could be a wearable, or other device where there is an advantage of transmission in a general sense to any device that also can be controlled in order to access the general transmission channel. This allows general communication from the device to the surrounding devices, as well as to allow user controlled data transfer and/or exchange. Further, through communications linkages through the private channel, the user may change the transmission status of the secondary device. This would be useful if the secondary device becomes lost. Anyone within the general area would be able to detect the lost device by locating it using the general short range communications channel.

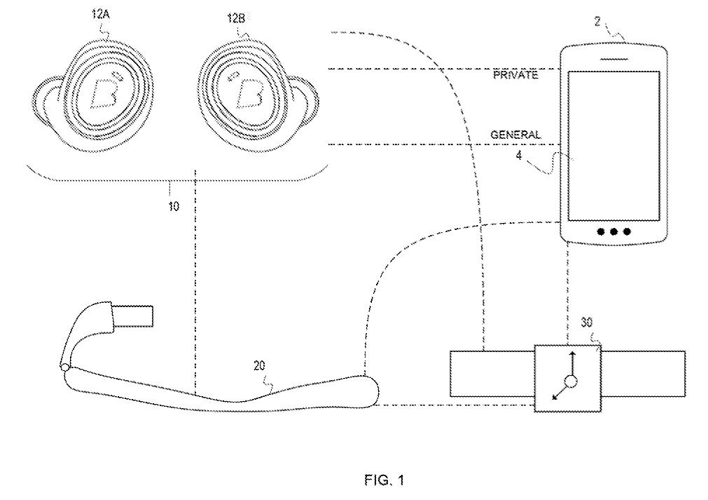

FIG. 1 illustrates an example of different devices which may be in operative communication with one another. A mobile device such as a mobile phone 2 is shown which includes a display. Also shown is a set of earpieces 10 which may include a left earpiece 12A and a right earpiece 12B. An eyepiece 20 is shown as is a watch 30. The earpieces 12A, 12B, the eyepiece 20, and the watch 30 are examples of wearable devices. Other types of wearable devices may also be used such as articles of clothing, jewelry or accessories, or other wearable items. Of course, the present invention is not necessarily limited to wearable devices.

As shown in FIG. 1, various items are in operative communication with each other. Communication can occur using any number of different communication systems and technologies. For example, communications may be Bluetooth or BLE communications, WiFi communications, UWB communications, or other types of radio communications. Between any of the devices there may be a private communications channel and a general communications channel. Private communications are generally secure communications which may be established using encryption and decryption. The general communications channel is available to others and thus any device may communicate voice and/or data over a general communications channel with any number of other devices with no security or at least less security then associated with the private communications channel.

There may be benefits to communicating certain information over a general communications channel. For example, there are instances where it may be desirable to communicate information in a manner similar to a beacon allowing any number of different devices access to the information. One example of such a use is where a device is lost and cannot be physically located. In such an instance, it is desirable for any number of other devices to be able to connect with the lost device as doing so would assist in finding the lost device. Similarly, there are other instances where it may be useful to have a beaconing mode or otherwise allow a device to communicate with any number of other devices without regard to privacy. For example, where there is a single source of data, audio, or video which is intended to be shared with multiple devices or users. One such example of such a need arises when a device transmits voice or data from a privileged location, such as a stethoscope placed over the heart. Heart sounds are unique and variable based upon position. They also may be transient and intermittent. Consequently, the need arises for the transmission from a wearable device to transfer voice or data streams from the position that they occupy to any available receiver that is within range.

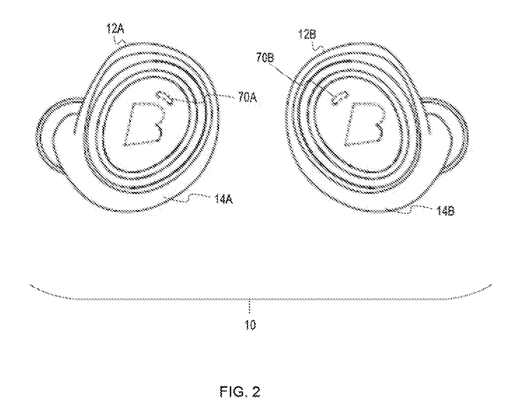

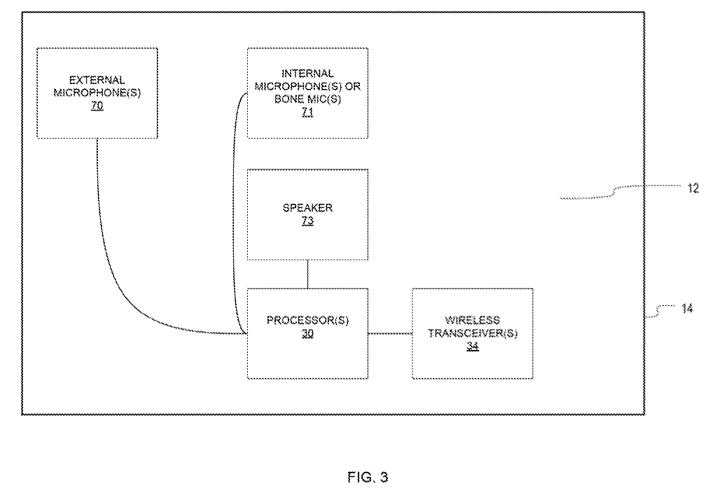

FIG. 2 illustrates one example of a device in greater detail. A set of earpieces 10 includes a left earpiece wearable 12A with an associated housing 14A. A microphone 70A for sensing audio is also shown. Similarly, a right earpiece wearable 12B with an associated housing 12B is shown with a microphone 70B for sensing audio is also shown. FIG. 3 is a block diagram showing a device 12 with a housing 14. Disposed within the device 14 is a processor 30 which is operatively connected to one or more wireless transceivers 34 which together may form a communication system. Various sensors such as an external microphone 70 and internal microphone 71 may also be present as well as a speaker 73. It is to be understood, however, that different wearable devices may have different sensors and combinations of sensors. The earpiece shown in FIG. 2 and FIG. 3 is configured to communicate over a general transmission channel or over private transmission channels. Thus, the earpiece may function as a beacon to communicate information to a number of different devices within proximity to the earpiece or the earpiece may function over secure wireless linkages to one or more particular devices. In addition, one may remotely send an instruction to the earpiece to instruct the earpiece to transition to or from a general transmission channel.

A user may control the device to select whether a general channel for transmission and reception of data is to be used. Thus, if the user wishes to send communications to or receive communications from other devices in close spatial relationship, the user may choose to do so (or not). Thus, user or device may determine whether to participate in the sharing or exchange of voice or data communicated through the general communications channel. Similarly, the user may decide to selectively terminate the sharing or exchange of voice or data through the general channel. In addition, a user may be allowed to find other devices within the general area by selecting the general channel. In addition, the device may act as a beacon if the linkage from the private communications channel to the device initiates the transmission on the general channel.

The device may be controlled in any number of different ways. For example, a device may be controlled through voice control, or through use of a touchscreen display on the device or on another device in operative communication with the device. Thus, for example, returning to FIG. 1, the earpieces 10 may be controlled in various ways such as through voice control to select the general communications channel, or through gesture control, or other user movement, or using another device such as the mobile device 2 to select the general communications channel. Of course, other methods of selecting the general communications channel may be used.

Therefore a method for generalized short range communication has been shown and described. The present invention contemplates numerous variations, options, and alternatives including in the type of transceiver(s) used, the communications protocols used, the type of devices, the type of wearable devices, and various other options, variations, and alternatives.

What is claimed is:

1. A method for generalized short range communication, comprising:
establishing a general channel communications linkage for transmission of voice or data from a primary device;
communicating the voice or data from the primary device to one or more secondary devices over the general channel;
establishing a private channel communications linkage for transmission of data between the primary device and the one or more secondary devices;
changing transmission status of the one or more secondary devices to provide for communications across the general channel communications linkage.

2. The method of claim 1 wherein the primary device is a wearable device.

3. The method of claim 2 wherein the wearable device is an earpiece.

4. The method of claim 1 wherein one or more of the secondary devices is a wearable device.

5. The method of claim 4 wherein the wearable device is an earpiece.

6. The method of claim 1 wherein the private channel communications linkage is encrypted.

7. The method of claim 6 wherein the general communications linkage is not encrypted.

8. A method for controlling communications of a device, the method comprising:
providing a device having a communications system comprising at least one transceiver and configured for establishing a general communications channel with one or more other devices and a private communications channel with one or more other devices;
receiving over the private communications channel an instruction to establish the general communications channel and transmit data over the general communications channel;
in response to the instruction, establishing the general communications channel and transmitting data over the general communications channel.

9. The method of claim 8 wherein the private communications channel encrypts and decrypts data communicated therethrough.

10. The method of claim 9 wherein the general communications linkage does not encrypt or decrypt data communicated therethrough.

11. The method of claim 10 wherein the device is a wearable device.

12. The method of claim 11 wherein the wearable device is an earpiece.

13. The method of claim 8 wherein the data transmitted over the general communications channel assists in locating the device.

14. A device, comprising:
a housing;
a transceiver disposed within the housing;
a processor operatively connected to the transceiver;
wherein the device is configured to establish a general communications channel for unencrypted communications and a private communications channel for encrypted communications;
wherein the device is configured to receive an instruction over the private communications channel and in response to the instruction communicate voice or data over the general communications channel.

15. The device of claim 14 wherein the device is a wearable device and wherein the housing is a wearable device housing.

16. The device of claim 15 wherein the wearable device is an earpiece.

17. The device of claim 15 wherein the wearable device is an eyepiece.

18. The device of claim 15 wherein the wearable device is timepiece.

19. A system comprising a plurality of the devices of claim 14.
